(19) United States
(12) Patent Application Publication
(10) Pub. No.: US 2021/0314519 A1
(43) Pub. Date: Oct. 7, 2021

(54) SPORTING EVENT TELEVISION BROADCAST EQUIPMENT AND SYSTEM

(71) Applicant: Alpha Opco, LLC, Beverly Hills, CA (US)

(72) Inventors: Sam Schwartzstein, Stamford, CT (US); Lars Osterlind, Burlington, NJ (US); Brian P. Raynes, Madbury, NH (US)

(21) Appl. No.: 17/222,610

(22) Filed: Apr. 5, 2021

Related U.S. Application Data
(60) Provisional application No. 63/005,066, filed on Apr. 3, 2020.

(51) Int. Cl. H04N 5/60; H04N 21/439; H04N 5/64; A42B 3/30; H04R 3/00

(52) U.S. Cl. CPC H04N 5/602; H04N 21/439; H04R 2420/07; A42B 3/30; H04R 3/005; H04N 5/642

(57) ABSTRACT

Sporting event television broadcast equipment and systems, particularly for football games, pickups live audio from the teams' coaches for inclusion in the broadcast of the game, thereby greatly enhancing the viewing experience for television viewers of the game. The audio feeds can include always-on microphone pickup from each team's head coach, as well as offensive and defensive play calls that are radioed from each team's assistant coaches to players on the field.

### CROSS-REFERENCE TO RELATED APPLICATIONS

This application claims the benefit of priority to U.S. provisional patent application 63/005,066, filed Apr. 3, 2020.

### BACKGROUND

During most televised professional and high-level college football games, a team's head coach and assistant coaches (including assistant coaches on the sideline and in the coaches' booth) wear headsets with microphones in order to communicate with each other during the game, but live audio feeds of the coaches are not typically part of the television broadcast.

### SUMMARY

In one general aspect, the present invention is directed to sporting event television broadcast equipment and systems, particularly for football games, that pickup live audio from the teams' coaches for inclusion in the broadcast of the game, thereby greatly enhancing the viewing experience for television viewers of the game. The audio feeds can include always-on microphone pickup from each team's head coach, as well as offensive and defensive play calls that are radioed from each team's assistant coaches to players on the field.

In various embodiments, the coaches for each team use communication units that comprise a speaker, a microphone and a radio transceiver so that the coaches for each of the teams can communicate during the game via respective intercom systems for each team. In addition, certain (and maybe all) players on each team wear helmet receivers in their football helmets. The helmet receivers receive play calls from assistant coaches on each team via radio transmissions. That is, for example, offense players on a first team receive offense play calls from a first team offense play-calling assistant coach; defense players on the first team receive defense play calls from a first team defense play-calling assistant coach; offense players on a second team receive offense play calls from a second team offense play-calling assistant coach; and defense players on the second team receive defense play calls from a second team defense play-calling assistant coach. The broadcast system also includes radio equipment that intercepts those radio transmissions and forwards them to the television broadcast truck at the game for inclusion in the television broadcast of the game. Those audio feeds can include, as mentioned above, the live microphone-pickups from each team's head coach, as well as the offense and defense play calls for each team. These and other benefits and advantages realizable through and with the present invention will be apparent from the description below.

### FIGURES

Various embodiments of the present invention are described herein by way of example in conjunction with the following figures.

FIGS. 1 and 2 are block diagrams of a communication system for a football game television broadcast according to various embodiments of the present invention. FIG. 1 depicts aspects for both teams, whereas FIG. 2 focuses on aspects of the communication for one of the two teams.

FIG. 3 is a block diagram of one of the team's transmitter packs illustrated in FIGS. 1 and 2. The two teams' transmitter packs can be identical.

### DESCRIPTION

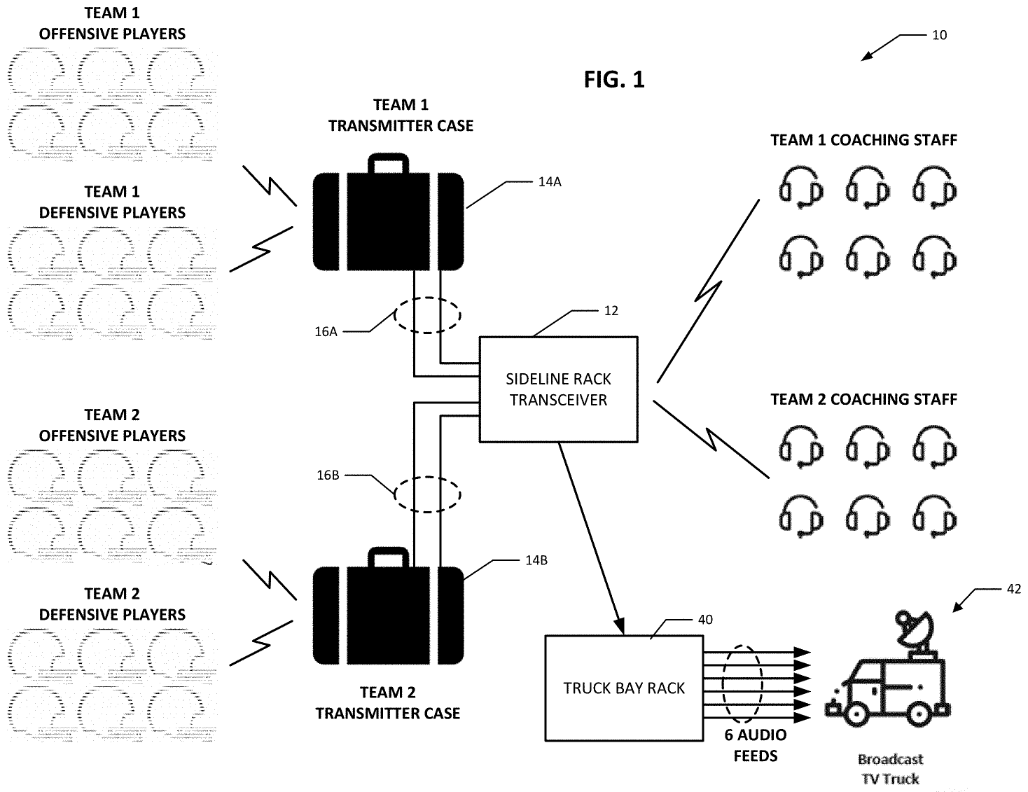

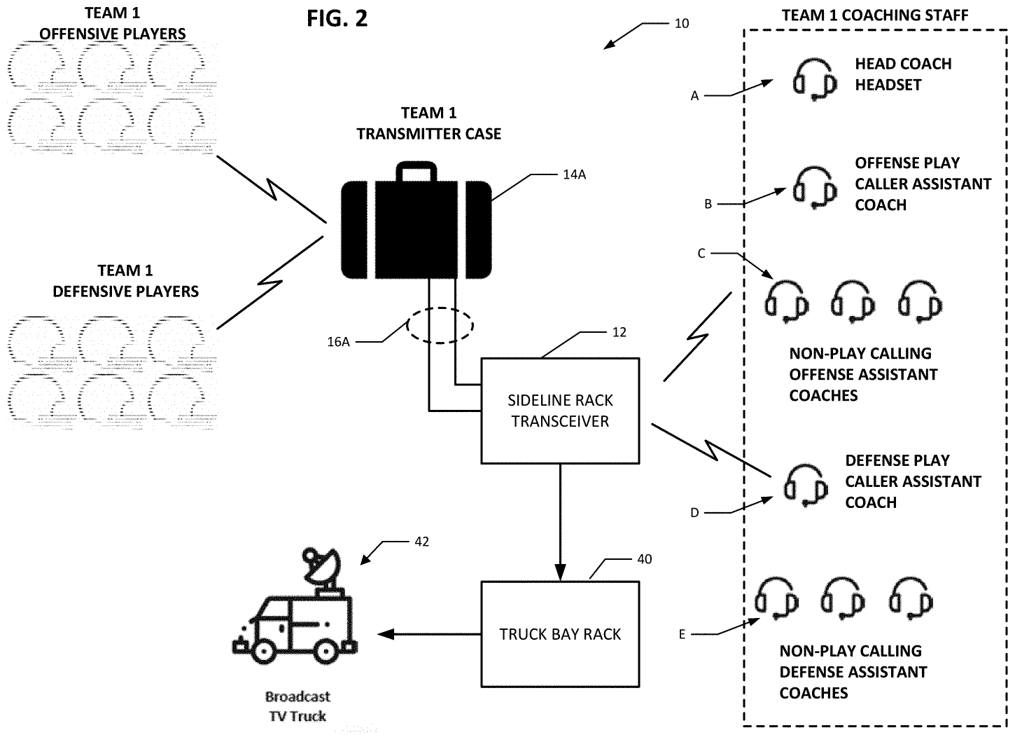

FIGS. 1 and 2 illustrate a sporting event television broadcast system 10 according to various embodiments of the present invention. The description below assumes that the broadcast system 10 is used for football games, although the broadcast system 10 could be used for other types of competitive sporting events or competitions if desired. The broadcast system 10 is also preferably for live broadcasts, although broadcasts could also be recorded later viewing, such as a later television broadcast or Internet streaming or download.

FIG. 1 depicts the broadcast system for both football teams (denoted as Team 1 and Team 2 in FIG. 1) and FIG. 2 is a more in-depth depiction of the broadcast system 10 for one of the teams (Team 1). Each player on each of the two teams is assigned a football helmet to where when playing in the game. The helmets of all or just some of the players on each team can comprise a helmet receiver. The helmet receiver comprises a radio receiver that can receive radioed play calls from play-calling assistant coaches of the respective teams, as described further below. The helmet receivers can be powered with rechargeable batteries and the helmet receivers can be, for example, wedged securely between shock absorbing pads on the inside of the players' helmets. That way, the helmet receivers can stay in place in the helmets during the game without requiring structural modifications to the helmet; and can be easily replaced if necessary without having to replace the helmet itself The Xl2MR helmet receiver from ProCom Technologies is an example of a suitable helmet receiver. The number of offensive and defensive players on each team that wear a helmet with a helmet receiver during a game can vary depending on circumstances. The broadcast system 10 is preferably set up so that the number of offensive players on each team that wear a helmet with a helmet receiver during the game is the same, and so that the number of defensive players on each team that wear a helmet with a helmet receiver during the game is the same. For example, the number of offensive players on each team that wear a helmet with a helmet receiver during the game may be around 15 to 20, whereas the number of defensive players on each team that wear a helmet with a helmet receiver during the game may be around 5 to 10. Each helmet receiver can be keyed, as appropriate, to the offensive or defensive play calls, as the case may be, for only one team. That way, the players do not receive the play calls of the other team, and offensive players do not receive defensive play calls of their own team and vice versa.

As shown in FIGS. 1 and 2, coaches for both teams wear communication units that comprise a headset and a corresponding belt pack that allow the coaches to communicate on wireless intercom systems. The headsets comprise an acoustic speaker and a microphone. The belt packs, which can be connected to the headsets via a cord, comprise a two-way radio transceiver. Each team's coaching staff could have five different groups of coaches as shown in FIG. 2, which show the five groups of coaches for Team 1. Team 2 could have identical coaching groups. The groups include (A) a head coach, (B) an offense play-calling assistant coach, (C) one or more other offense assistant coaches, (D) a defense play-calling assistant coach, and (E) one or more other defense assistant coaches. The coaches in different groups can have different switches on their communication units to control to whom they communicate. In various embodiments, for one of the teams (e.g., Team 1), the offense play-calling assistant coach and the offense assistant coaches can communicate wirelessly on one (a “first”) radio channel; the defense play-calling assistant coach and the defense assistant coaches can communicate wirelessly on another (a “second”) radio channel; the head coach can communicate with both the offensive coaches on the first channel and the defensive coaches on the second channel, but can only communicate on one of the channels at a time. The head coaches typically are on the sidelines during the football game. The offensive and defensive assistant coaches may be on the sidelines or in a respective coaches' booth for each team at the game venue.

In various embodiments, the communication units may transmit in the 1.880 to 1.930 GHz DECT frequency band. One or more antennas for the network may be set up throughout the venue for the football game to link the communication units. The coaches' communication units may be implemented with Bolero brand headsets and belt packs from Riedel Communications, for example.

The broadcast system further comprises, as shown in FIGS. 1 and 2, a sideline rack transceiver 12, a Team 1 transmitter case 14A, and a Team 2 transmitter case 14B, all of which are preferably positioned during the game on the field behind or near one of the team's bench. The sideline rack transceiver 12 preferably comprises two radio transceivers that communicate wirelessly with the communication units of the coaching staffs of each team. Only one sideline rack transceiver 12 is shown for the sake of simplicity. In other embodiments, the system 10 could include multiple sideline rack transceivers.

In various embodiments, the coaches may communicate via full duplex, digital and encrypted, radio transmissions. That way, multiple coaches can transmit simultaneously on the teams' respective intercom systems. In various embodiments, the microphones of the headsets of the two head coaches' communication units are always “live” (i.e., always picking up audio) during the game. The belt pack for each head coach may include a mechanical “platoon” switch or button (e.g., a toggle switch) that the head coach controls so that it is in one of two positions—offense or defense. When the platoon switch is in the offense position, the mic pickups from the head coach's headset are transmitted to the offensive assistant coaches (including the play-calling offensive assistant coach) for that team. Conversely, when the platoon switch is in the defense position, the mic pickups from the head coach's headset are transmitted to the defensive assistant coaches (including the play-calling defensive assistant coach) for that team.

In various embodiments, the mics from the assistant coaches' headset are not always on. Instead, the belt pack or headset of each assistant coach communication unit may comprise a “Talk” button that the assistant coach presses to transmit to the other offensive or defensive (as the case may be) assistant coaches and the head coach for that assistant coach's team. That is, for example, for a time period that an offensive assistant coach for Team 1 depresses the Talk button on that assistant coach's communication unit, the microphone on that assistant coach's headset will pick up audible utterances from that assistant coach, and the two-way radio transceiver in the belt pack of that assistant coach's communication unit sends a digitized, encrypted radio transmission of the captured audio of the assistant coach. The sideline rack transceiver 12, in real-time, receives and decrypts the radio transmission and resends it, again digitized and decrypted, to the communication units of the other offensive assistant coaches and the head coach for Team 1 in this example. Team 1's head coach, however, will only hear the transmission if the platoon switch of the head coach's communication unit is in the offense position. If the platoon switch of the head coach's communication unit is in the defense position, the communication unit for Team 1's head coach will not play the transmission from the Team 1 offensive assistant coach.

The radio transmissions for the defensive coaches for Team 1 operate in an analogous way, and the radio transmissions (offensive and defensive) for Team 2 operate analogously to Team 1. The offensive and defensive channels for Team 1 are different than the offensive and defensive channels for Team 2, so that there is no cross talk or eavesdropping between the teams' coaches.

As mentioned above, where full duplex, two-way radio transmissions are used for the coaches' communication units, multiple coaches on one channel can transmit simultaneously.

In various embodiments, one offensive assistant coach and one defensive assistant coach for each time has play-calling abilities, where the play calls from those designated assistant coaches are transmitted wirelessly to certain helmet receivers of the players for that team. For example: play calls from the offensive assistant coach for Team 1 are transmitted to offensive players on Team 1 that have helmet receivers; play calls from the defensive assistant coach for Team 1 are transmitted to defensive players on Team 1 that have helmet receivers; play calls from the offensive assistant coach for Team 2 are transmitted to offensive players on Team 2 that have helmet receivers; and play calls from the defensive assistant coach for Team 2 are transmitted to defensive players on Team 2 that have helmet receivers. In order to transmit the play calls, the communication units of the designated offensive and defensive play-calling assistant coaches for each team have a “Play Call” button (in addition to the aforementioned “Talk” button). In operation, when a play-calling assistant coaches calls a play, the playing calling assistant coach depresses the “Play Call” button on his/her communication unit, which causes the microphone on his/her communication unit to pick up the audible utterance of the play call and causes the play-calling assistant coach's communication unit to transmit a radio transmission with the play call to the sideline rack transceiver 12. The play call is preferably on same radio channel as the communications amongst the other offense/defense assistant coaches. That way, all of the offensive and defensive coaches (as the case may be) and the head coach hear the play call on the offense/defense channel.

As shown in FIGS. 1 and 2, the sideline rack transceiver 12 is in communication with the Team 1 and Team 2 transmitter cases 14A, 14B. The sideline rack transceiver 12 is preferably connected to the transmitter cases 14A, 14B via XLR terminated audio cables. Also as shown in FIGS. 1 and 2, there can be two links from the sideline rack transceiver 12 to the respective Team 1 and Team 2 transmitter cases 14A, 14B-one link for offense and one link for defense.

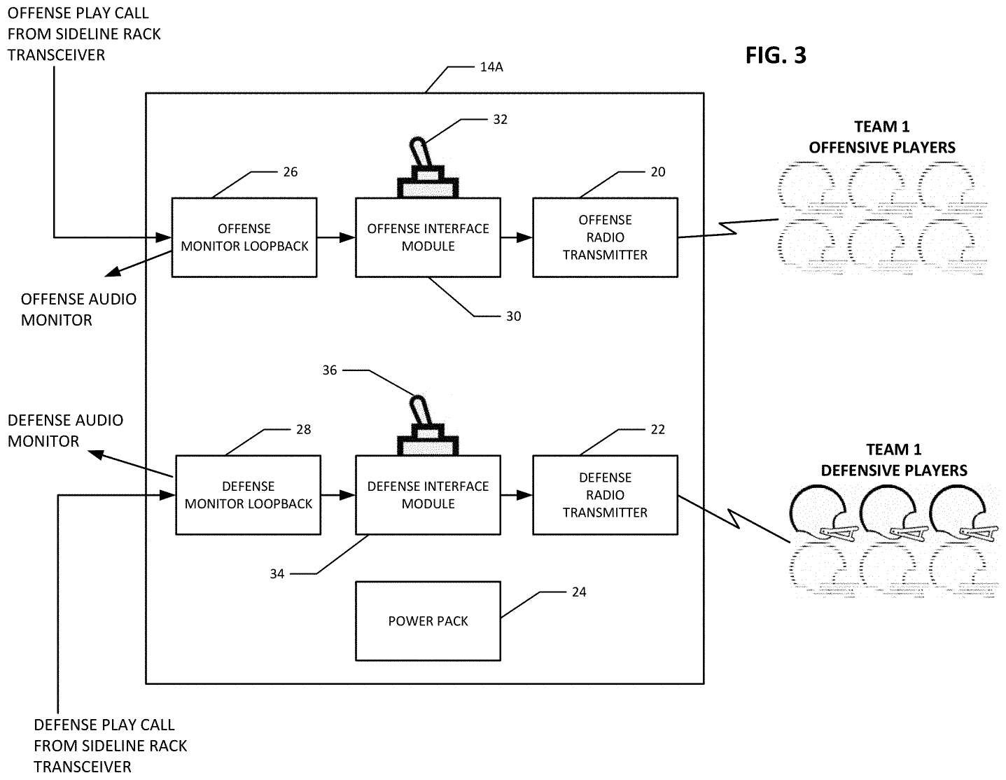

FIG. 3 is a block diagram of one of the transmitter cases, in this case the Team 1 transmitter case 14A. The Team 2 transmitter case 14B can be identical to the Team 1 transmitter case 14A, except that the Team 2 transmitter case 14B is keyed to and communicates with the Team 2 helmet receivers. As shown in FIG. 3, each transmitter case can comprise two transmitters-one transmitter 20 for offense and one transmitter 22 for defense. Each transmitter case 14A, 14B may also comprise a power pack 24, an offense monitor loopback 26, a defense monitor loopback 28, an offense interface module 30 with a mechanical toggle switch 32, and a defense interface module 34 with a mechanical toggle switch 36.

The offense and defense radio transmitters 20, 22 are keyed, preferably before the game, to respective offense and defense helmet modules for their team, so that the helmet modules can decode the radio transmissions to it. In operation, when an offense or defense playing calling assistant coach for Team 1 transmits a play call to the sideline rack transceiver 12 on the offense or defense play call channel for Team 1, as the case may be, as described above, the sideline rack transceiver 12 forwards the transmission to the Team 1 transmitter pack 14A via the communication links 16A. The audio is forwarded to the offense or defense radio transmitters 20, 22, as the case may be (i.e., offense play calls on the offense play call channel for Team 1 are forwarded to the offense radio transmitter 20 and defense play calls on the defense play call channel for Team 1 are forwarded to the defense radio transmitter 22). The offense or defense radio transmitters 20, 22, as the case may be, then radio the play call audio to the respective offense or defense players having the helmet receivers that are keyed to the appropriate radio transmitter 20, 22. In various embodiments, the radio transmissions from the offense and defense radio transmitters 20, 22 are one-way radio transmissions; that is, the helmet receivers do not transmit radio signals back to the transmitter case 14A.

The offense and defense monitor loopbacks 26, 28 receive the respective offense and defensive play call transmissions and provide an audio monitor loopback if desired. The play calls are forwarded to the offense and defense radio transmitters 20, 22 via the respective offense and defense interface modules 30, 34. In various embodiments, the offense and defense radio transmitters 20, 22 may be implemented, respectively, with the model Xl2 belt pack transmitters from ProCom Technologies. These transmitters have multiple channel capability, such that one channel could be used for offense and another channel used for defense, with a button on the radio transmitter to change or cycle through the channels. To avoid the need for a person(s) attending the transmitter packs 14A, 14B from having to switch the transmitters 20, 22 from offense to defense for each team as the game progressed, each transmitter pack 14A, 14B may have two transmitters 20, 22, as shown in FIG. 3 (one for offense and one for defense), and each transmitter 20, 22 has a corresponding interface module, e.g., the offense and defense interface modules 30, 34 shown in FIG. 3. Each interface module 30, 34 can comprise a mechanical, multiposition (e.g., on-off) switch, such as the toggle switches 32, 36 shown in FIG. 3. The offense and defense interface modules 30, 34 are configured to always transmit the received audio from the play-calling assistant coaches to their corresponding offense or defense radio transmitter 20, 22 when its corresponding switch 32, 36 is in the “on” position. As such, throughout the game, the offense radio transmitter 20 is set to the offense channel (e.g., the channel the communicates with the offense helmet receivers); also, the defense radio transmitter is set for the defense channel (e.g., the channel that communicates with the defense helmet receivers); and the switches 32, 36 may be set in the “on” position throughout the football game so that the offense and defense play calls are transmitted to the offense and defense players' helmet receivers, respectively, by the radio transmitters 20, 22. In various embodiments, the radio transmitters 20, 22 can transmit at a frequency of about 900 MHz. After the game, the switches 32, 36 can be switched to the “off” position. In various embodiments, the transmitters 22, 23 may each comprise rechargeable batteries. The power pack 24 may charge the rechargeable batteries in the transmitters 22, 23 with power from 120V AC mains for example.

As shown in FIGS. 1 and 2, the transmitter cases 14A, 14B may be in the form of portable cases, such as portable suitcases or the like, with a handle and lock. In various embodiments, each team has its own transmitter case that it brings to the game. A team representative can check, prior to the game, that the transmitters 22, 23 communicate properly with the helmet receivers for his/her team so that the players can effectively hear the play calls via their helmet receivers during the game.

Referring back to FIGS. 1 and 2, the sideline rack transceiver 12 also may be in communication with a truck bay rack 40 that is, in turn, in communication with a broadcast TV truck 42. The communication links between the sideline rack transceiver 12 and the truck bay rack 40, and between the truck bay rack 40 and the broadcast TV truck, may comprise fiber optical cables. Those communication links can carry, for example, six audio feeds: Team 1 always-on head coach mic; Team 1 offensive play calls; Team 1 defensive play calls; Team 2 always-on head coach mic; Team 2 offensive play calls; and Team 2 defensive play calls. That is, for example, the sideline rack transceiver 12 receives the always-on mic pickup radio transmissions from head coach headset from each team and forwards that audio to the broadcast TV truck 42, via the truck bay rack 40, for inclusion in the TV broadcast of the football game. Similarly, the sideline rack transceiver 12 receives the play calls from each team's play-calling assistant coaches on the Play Call channels and forwards those transmissions to the broadcast TV truck 42, via the truck bay rack 40, for inclusion in the TV broadcast of the football game.

As is apparent from the description above, the first team's coaches are not part of the intercom system for the second team and vice versa. That way, the first team's coaches cannot listen into the intercom communications by the second team's coaches during the game and vice versa. Also, the players and coaches of the first team cannot listen to the play calls from the second team, and vice versa.

In the description above, the players' helmet receivers did not include transmitters; they merely received the play calls via radio transmission. In other embodiments, some of the players' helmet modules could include microphones and radio transmitters. That way, captured audio picked up by the microphone of the players' helmet modules could be radioed back to the respective team's transmitter pack 14A, 14B, and forwarded to the sideline rack transceiver 12 to be forwarded to the broadcast TV truck 42 for inclusion in the game broadcast. In such an embodiment, the respective team's transmitter pack 14A, 14B include radio receivers to receive the audio radioed from the player's helmet modules.

Also, in some embodiments, some or all of the players could have helmets with helmet receiver module. Also, in various embodiments, there may be more that two channels per team, i.e., more than the offense and defense channels per team. For example, the offense alone might have multiple channels, such as separate channels for the “skill players” (e.g., quarterback, receivers, running backs) and the offensive linemen. Similarly, the defense could have multiple separate channels, such as channels for the linemen, linebackers and secondary. Also, specialty team players could have helmet modules for a dedicated special teams transmitter. In embodiments where multiple different groups are used, the transmitter cases could have a transmitter for each group. Also, each group may have its own assistant coach for calling the plays for the group or one coach could call the plays with multiple groups. In such a scenario, the assistant coach's communication headset could have one button for transmitting play calls to one group (e.g., skill players on offense) and another button for transmitting play calls to another group (e.g., offensive lineman). Also in such embodiments, all of the various play calls could be forwarded to the TV broadcast truck 42 for inclusion in the TV broadcast in a manner similar to that described above for the offensive and defensive play calls for each team.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. Further, it is to be understood that the figures and descriptions of the present invention have been simplified to illustrate elements that are relevant for a clear understanding of the present invention, while eliminating, for purposes of clarity, other elements. While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

What is claimed is:

1. A broadcast system, comprising:
a first communication unit including a microphone, a speaker, and a radio transceiver;
a second communication unit including a microphone, a speaker, and a radio transceiver;
a third communication unit including a microphone, a speaker, and a radio transceiver;
a plurality of receiver units, each receiver unit including a speaker;
a central transceiver unit including at least one transceiver, the central transceiver unit configured to receive communications from the first communication unit, the second communication unit, and the third communication unit; and
a central transmitter unit operatively coupled to the central transceiver unit, the central transmitter unit configured to receive communications from the central transceiver unit and to transmit communications to the plurality of receiver units.

2. The broadcast system of claim 1, wherein the first communication unit microphone is in an always-on configuration.

3. The broadcast system of claim 1, wherein the plurality of receiver units are disposed within helmets.

4. The broadcast system of claim 1, wherein the plurality of receiver units comprise a first subset of receiver units and a second subset of receiver units, the first subset of receiver units keyed to receive communications from the first communication unit and the second communication unit, and the second subset of receiver units keyed to receive communications from the first communication unit and the third communication unit.

5. The broadcast system of claim 1, further comprising:
a fourth communication unit including a microphone, a speaker, and a radio transceiver;
a fifth communication unit including a microphone, a speaker, and a radio transceiver,
wherein the second communication unit and the fourth communication unit communicate on a first channel, and
wherein the third communication unit and the fifth communication unit communicate on a second channel.

6. The broadcast system of claim 5, wherein the second communication unit and the third communication unit each include a selector to activate the second communication unit microphone and the third communication unit microphone, respectively, in order to communicate with the fourth communication unit and the fifth communication unit, respectively.

7. The broadcast system of claim 6, wherein the plurality of receiver units comprise a first subset of receiver units and a second subset of receiver units, wherein the second communication includes a second selector to concurrently communicate with the fourth communication unit and the first subset of receiver units, and wherein the third communication unit includes a third selector to concurrently communicate with the fifth communication unit and the second subset of receiver units.

8. The broadcast system of claim 5, wherein the first communication unit includes a switch to selectively communicate on either the first channel or the second channel.

9. The broadcast system of claim 1, wherein the central transceiver unit is disposed in a portable housing.

10. The broadcast system of claim 1, wherein communications from the first communication unit pass through the central transceiver before being communicated to any of the second communication unit, the third communication unit, or the plurality of receiver units.

11. The broadcast system of claim 10, wherein the first communication system communicates wirelessly with the central transceiver.

12. The broadcast system of claim 10, wherein communications to and from the central transceiver are encrypted.

13. The broadcast system of claim 1, wherein the central transmitter unit is a portable housing that includes at least one monitor loopback module, at least one interface module, at least one transmitter, and a power supply.

14. The broadcast system of claim 13, wherein the plurality of receiver units comprises a first subset of receiver units and a second subset of receiver units, wherein the at least one transmitter comprises a first transmitter and a second transmitter, wherein the first transmitter is configured to communicate with the first subset of receiver units, and wherein the second transmitter is configured to communicate with the second subset of receiver units.

15. The broadcast system of claim 13, where the at least one transmitter includes a battery, and wherein the battery is electrically coupled to the power supply.

16. The broadcast system of claim 1, wherein the central transceiver unit is configured to communicate with a television broadcast system.

17. The broadcast system of claim 16, wherein communications from at least one of the first communication unit, the second communication unit, or the third communication unit are communicated to the television broadcast system to be included as part of a television broadcast.

18. The broadcast system of claim 1, wherein the plurality of receiver units includes a first subset of receiver units and a second subset of receiver units, and wherein the second communication unit includes a selector to selectively communicate with either the first subset or the second subset of receiver units.

19. The broadcast system of claim 1, wherein communications into the transceiver unit and communications out of the transmitter unit are encrypted.

20. A television broadcast system for broadcasting a football game played at a venue between a first team and a second team, wherein each team comprises players and coaches, and the coaches for each team from a head coach and multiple assistant coaches, the television broadcast system comprising:
a first team intercom system through which the first team coaches communicate during the football game, wherein the first team intercom system comprises a plurality of first team coach communication units, wherein each of the first team coach communication units comprises a speaker, a microphone, and a radio transceiver;
a second team intercom system through which the second team coaches communicate during the football game, wherein the second team intercom system comprises a plurality of second team coach communication units, wherein each of the second team coach communication units comprises a speaker, a microphone, and a radio transceiver;
a sideline rack transceiver that comprises:
a first team transceiver for receiving radio transmission of the first team coaches over the first team intercom system; and
a second team transceiver for receiving radio transmission of the second team coaches over the second team intercom system; and
a plurality of first team helmet receivers that are positioned in helmets of first team players, wherein the plurality of first team helmet receivers comprise:
a set of offense helmet receivers for offensive players on the first team; and a set of defense helmet receivers for defensive players on the first team;
a plurality of second team helmet receivers that are positioned in helmets of second team players, wherein the plurality of second team helmet receivers comprise:
a set of offense helmet receivers for offensive players on the second team; and a set of defense helmet receivers for defensive players on the second team;
a first team transmitter pack having a communication link to the sideline rack transceiver, wherein the first team transmitter pack comprises:
a first team offense radio interface module for receiving first team offense play calls, via first team transceiver of the sideline rack transceiver, from an offense play-calling assistant coach of the first team, wherein the first team offense radio interface module comprises an on-off switch;
a first team offense radio transmitter connected to the first team offense radio interface module for transmitting wirelessly the first team offense play calls to the set of offense helmet receivers for offensive players on the first team when the on-off switch of the first team offense radio interface module is in the on position;
a first team defense radio interface module for receiving first team defense play calls, via the first team transceiver of sideline rack transceiver, from a defense play-calling assistant coach of the first team, wherein the first team defense radio interface module comprises an on-off switch;
a first team defense radio transmitter connected to the first team defense radio interface module for transmitting wirelessly the first team defense play calls to the set of defense helmet receivers for offensive players on the first team when the on-off switch of the first team defense radio interface module is in the on position;
a second team transmitter pack having a communication link to the sideline rack, wherein the second team transmitter pack comprises:
a second team offense radio interface module for receiving first team offense play calls, via the second team transceiver of sideline rack transceiver, from an offense play-calling assistant coach of the second team, wherein the second team offense radio interface module comprises an on-off switch;
a second team offense radio transmitter connected to the second team offense radio interface module for transmitting wirelessly the second team offense play calls to the set of offense helmet receivers for offensive players on the second team when the on-off switch of the second team offense radio interface module is in the on position;
a second team defense radio interface module for receiving first team defense play calls, via the second team transceiver of sideline rack transceiver, from a defense play-calling assistant coach of the second team, wherein the second team defense radio interface module comprises an on-off switch;
a second team defense radio transmitter connected to the second team defense radio interface module for transmitting wirelessly the second team defense play calls to the set of defense helmet receivers for offensive players on the second team when the on-off switch of the second team defense radio interface module is in the on position;
wherein the sideline rack transceiver is in communication with a television broadcast truck and the sideline rack transceiver is configured to transmit audio feeds to the television broadcast truck during the football game, wherein the audio feeds comprise:
a first audio feed from the microphone of the communication unit of a head coach of the first team;
a second audio feed from the microphone of the communication unit of a head coach of the second team;
a third audio feed that comprises the first team offense play calls;
a fourth audio feed that comprises the first team defense play calls;
a fifth audio feed that comprises the second team offense play calls; and a sixth audio feed that comprises the second team defense play calls.
